(19) United States
(12) Patent Application Publication
(10) Pub. No.: US 2011/0299168 A1
(43) Pub. Date: Dec. 8, 2011

(54) Display Screen Covers Having Personalized Refractive Power Capabilities

(76) Inventor: Jeffrey S. Combs, Indianapolis, IN (US)

(21) Appl. No.: 12/794,022

(22) Filed: Jun. 4, 2010

(51) Int. Cl. G02B 1/11

(52) U.S. Cl. 359/601

(57) ABSTRACT

Described are methods and systems for forming personalized display screen covers and the resulting covers produced therefrom. The display screen covers include personalized refractive power capabilities corresponding to users' refractive error prescriptions. The display screen covers may be configured to releasably adhere to display screens of electronic devices, such as clinging to screens owing to static electricity. The display screen covers may be formed from substantially thin, flexible and transparent material pieces. Additionally, the display screen covers may optionally be coated with mediums for reducing glare and/or filtering radiation. Further, the display screen covers may be provided in personalized sets having a plurality of covers in various sizes.

### FIELD OF THE DISCLOSURE

The present disclosure relates generally to devices having personalized refractive power capabilities and, in particular aspects, to display screen covers having personalized refractive power capabilities, and systems and methods for forming such covers.

### BACKGROUND

As further background, there exist various optical devices for placement with respect to a display screen such as a computer monitor in order to magnify or filter the image on the monitor. However, many of these devices are difficult to correctly position and do not account for other refractive errors. Additionally, when viewing such display screens, individuals with refractive error are required to wear vision-correction articles to improve the individuals' vision of the display screens.

Accordingly, there remain needs for improved and/or alternative systems, methods and devices for display screen covers having personalized refractive power capabilities so that users may avoid wearing vision-correction articles. The present disclosure is addressed to those needs.

### SUMMARY

The present disclosure provides, in certain aspects, unique methods and systems for forming personalized display screen covers and the resulting covers formed therefrom. In certain other embodiments, the present disclosure provides unique methods and systems for forming thin and flexible display screen covers configured to releasably adhere to display screens. In certain other embodiments, the present disclosure provides unique display screen covers personalized for particular users by incorporating the users' personalized refractive error prescriptions to enable viewing of display screens without the need for wearable vision-correction articles. Additionally, the present disclosure optionally provides for unique personalized display screen covers having tinting, glare-reducing and/or radiation-filtering features.

In one particular example embodiment, a unique method for forming a personalized display screen cover includes receiving a user's personalized refractive error prescription corresponding to the user's refractive error in vision, providing a blank film sheet, and developing the blank film sheet into a personalized display screen cover. The developing includes forming the blank film sheet to include refractive power corresponding to the prescription. The resulting personalized display screen cover is provided to the user for use with a display screen.

In another particular example embodiment, a set of personalized display screen covers may be formed and provided to a user. The set may include a plurality of covers, each including refractive power corresponding to the user's refractive error prescription, the covers being of different sizes to enable application to different-sized display screens.

Other objects, embodiments, forms, features, advantages, aspects, and benefits of the present disclosure shall become apparent from the detailed description and drawings included herein.

### BRIEF DESCRIPTION OF THE DRAWINGS

FIG. 1 is a perspective view of a display screen cover according to an embodiment of the present disclosure.

FIGS. 2A and 2B are perspective views of a display screen cover for use with a computer system according to an embodiment of the present disclosure.

FIG. 3 is a perspective view of a display screen cover for use with a cellular telephone according to an embodiment of the present disclosure.

FIG. 4 is a perspective view of a display screen cover for use with a camera according to an embodiment of the present disclosure.

FIG. 5 is a perspective view of a display screen cover for use with a laptop computer according to an embodiment of the present disclosure.

FIG. 6 is a perspective view of a display screen cover for use with a television according to an embodiment of the present disclosure.

FIG. 7 is a perspective view of a display screen cover according to an embodiment of the present disclosure.

FIG. 8 is a perspective view of a set of different-sized display screen covers according to an embodiment of the present disclosure.

FIG. 9 is a flow chart describing an example method according to an embodiment of the present disclosure.

### DETAILED DESCRIPTION

While the present disclosure may be embodied in many different forms, for the purpose of promoting an understanding of the principles of the present disclosure, reference will now be made to the embodiments illustrated in the drawings, and specific language will be used to describe the same. It will nevertheless be understood that no limitation of the scope of the disclosure is thereby intended. Any alterations and further modifications in the described embodiments and any further applications of the principles of the present disclosure as described herein are contemplated as would normally occur to one skilled in the art to which the disclosure relates.

In certain aspects, the present disclosure provides unique methods and systems for forming display screen covers having personalized refractive power capabilities and the resulting covers formed therefrom. The covers may be configured to releasably adhere to a display screen of an electronic device. Additionally, the personalized refractive power capabilities of the covers correspond to the particular users' refractive error prescriptions. In this way, the covers enhance each user's vision of a corresponding display screen and, in certain situations, can eliminate the need for the user to wear vision-correction articles, such as eye glasses or contact lenses, to view the display screen.

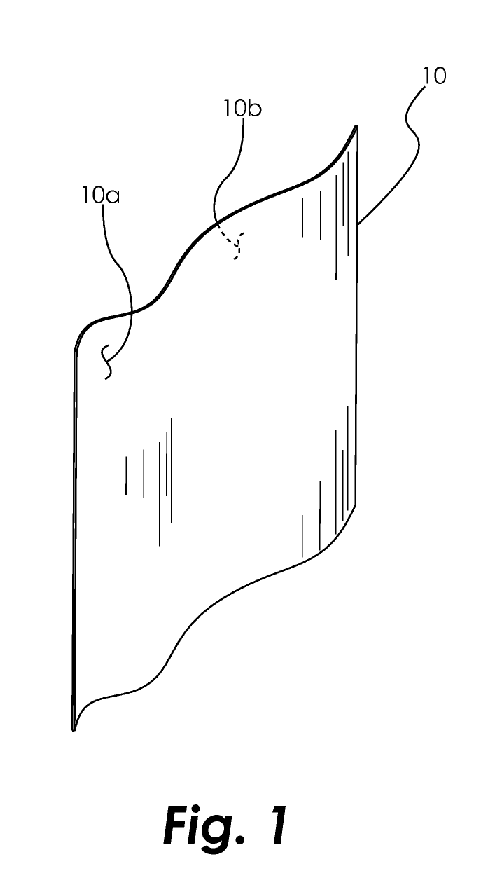

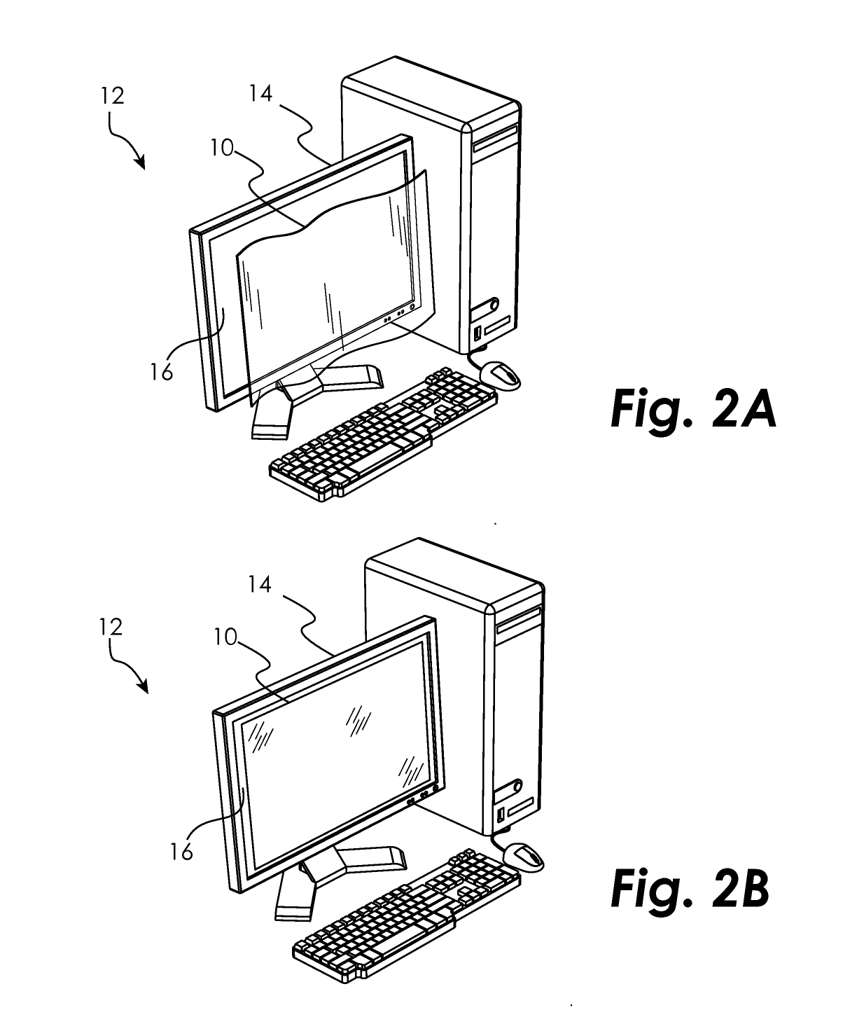

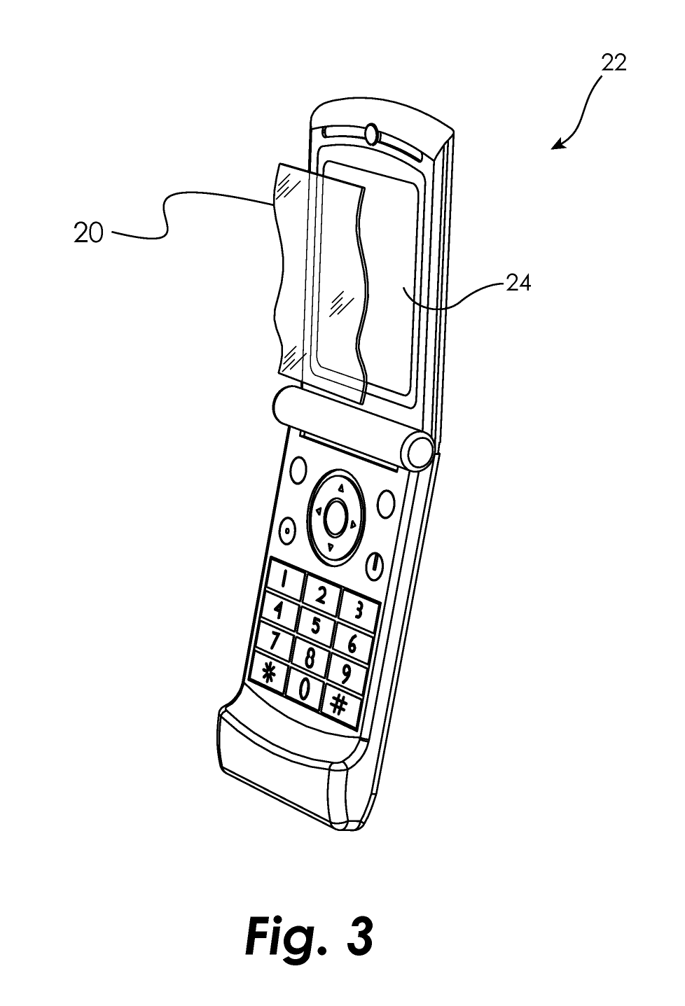

Referring to FIGS. 1-2B, there is shown an example cover 10 having personalized refractive power capabilities and designed for use with a display screen. The illustrated display screen cover 10 is a relatively thin and flexible material piece having a first side 10a and an opposite second side 10b. In the particular application illustrated in FIGS. 2A-2B, cover 10 is configured for use with a computer system 12 having a monitor 14 with a display screen 16. As shown in FIGS. 2A-2B, cover 10 may be applied to screen 16 to enhance a user's vision of the display screen, with second side 10b contacting display screen 16. Other example applications of display screen covers contemplated by the present disclosure are depicted in FIGS. 3-6 (discussed in greater detail below). It should be appreciated that the various embodiments, options, and/or alternatives discussed with respect to a particular display screen cover apply to all display screen covers contemplated by the present disclosure.

In certain embodiments, the display screen cover contemplated by the present disclosure has a relatively small thickness, the cover being sufficiently thin that a necessary amount of illumination from the display screen penetrates through the cover. In one particular embodiment, the display screen cover has a thickness of less than 5 millimeters. In other embodiments, the display screen cover has a thickness of less than 1 millimeter. As such, the display screen cover may be composed of a thin film-like material. However, it should be appreciated that the display screen cover can be designed with a greater or lesser thickness as would occur to one of ordinary skill in the art. In alternative embodiments, the display screen cover may be composed of a thicker, more rigid material.

Additionally, the display screen cover may be configured to releasably adhere to a display screen to allow for selective, temporary application. As one example, the cover may be designed to cling to a display screen owing to static electricity, also referred to as adherence via static cling. As another example, the cover may be designed to adhere to a display screen through the use of adhesive material. In certain embodiments, pressure sensitive adhesive may be utilized to releasably adhere the cover to a display screen. In some preferred embodiments, the particular adhesive material used does not leave a substantial amount of residue on the display screen upon removal of the cover. It is contemplated that the cover may releasably adhere to a display screen in a variety of other appropriate manners as would occur to one of ordinary skill in the art.

In alternative embodiments, the display screen cover may be configured to adhere, mount or otherwise attach or engage with the frame or perimeter surrounding a display screen, with or without contacting the display screen itself, and in temporary, semi-permanent or permanent manners. As one example, the cover may be configured to releasably adhere to the frame of a computer monitor. As another example, the cover may be contained within a housing that is mounted to the frame surrounding the display screen. In such embodiments, the cover may be pulled out of the housing to cover the display screen and retracted back into the housing when not in use. Additionally, the housing may be manually operated or may be automatic, motorized and/or electronic in configuration.

Additionally, it is contemplated that the cover may be easily portable such that the cover may be selectively and temporarily applied to display screens as desired. In certain embodiments, the cover may be sufficiently flexible to be rolled up when not in use, such as during storage and transport, and unrolled for temporary selective application to a display screen. To enable such flexibility, it is contemplated that the cover may be composed of a thin and flexible plastic film material. However, it is contemplated that the cover may be formed from other appropriate materials having suitable refractive indexes as would occur to one of ordinary skill in the art. In alternative embodiments, the cover may be configured for semi-permanent or permanent application to a primary display screen and/or the frame surrounding a primary display screen.

The cover is preferably substantially transparent to allow illumination from a display screen to transmit through the cover. In optional embodiments, the cover may be configured with an anti-glare feature to prevent external light from creating glare on the display screen which can disrupt the user's vision of the display screen. In one particular example, the display screen cover may be coated on one or both sides with a medium adapted for reducing glare. As another example, the display screen may include a resin incorporated therein which is adapted for reducing glare. In other optional embodiments, the display screen cover may be configured with a radiation-filtering feature to prevent an amount of radiation from transmitting from the display screen to the user. Similar to the anti-glare feature, the radiation-filtering feature may be in the form of a coating applied to the display screen cover or may be in the form of a material incorporated into the cover. In yet other optional embodiments, the display screen cover may be tinted with a dark color so that the display screen is somewhat concealed when not illuminated.

The display screen covers contemplated by the present disclosure may be custom formed to include personalized refractive power capabilities corresponding to a particular user's refractive error prescription. As such, the display screen covers may occupy a variety of contours, shapes, designs, configurations and/or internal arrangements depending upon at least the specific refractive error prescription being resolved by the cover and the refractive index of the material used to form the cover. As examples, for a user having myopia (or nearsightedness), the user's display screen cover may include at least one portion, area or segment having a concave shape to address the myopia error in the user's vision. As another example, for a user having hyperopia (or farsightedness), the user's display screen cover may include at least one portion, area or segment having a convex shape to address the myopia error in the user's vision. Further, the personalized refractive power capabilities of the display screen cover may include at least one spherical diopeter value and at least one cylindrical diopeter value corresponding to the particular user's refractive error prescription.

In alternative embodiments, the display screen cover may be designed to provide direct magnified viewing of a display screen. In such embodiments, the display screen cover may be formed with one of a variety of magnification levels to enhance a user's vision of a display screen.

In situations in which a user has a first refractive error prescription for one eye and a second, different refractive error prescription for the other eye, the user's different refractive error prescriptions may be averaged to obtain an averaged refractive error prescription. The user's personalized display screen cover may be formed to include refractive power corresponding to the user's averaged refractive error prescription. The method of averaging the user's refractive error prescriptions is not critical to the present disclosure. In alternative embodiments, the user's personalized display screen cover may be formed to include refractive power corresponding to a combination refractive error prescription that is designed to address both the refractive error prescriptions for the left and right eye, although not a strict average of the prescriptions.

In certain embodiments, the display screen covers contemplated by the present disclosure may be formed to account for a standard distance between the user's eves and the display screen, the standard distance being based on the size of the display screen or the display screen cover. The standard distance may be the distance that a user should position herself from the display screen to optimize vision of the display screen while protecting the user's eyesight. To form the display screen cover in this manner, an appropriate formula may be used to determine the standard distance based on a dimension of the display screen or the display screen cover. When providing the display screen cover to the user, the standard distance may be conveyed to the user via a single dimension or range of dimensions. In alternative embodiments, the display screen cover may be custom-formed based on the particular distance that the user typically positions herself from the display screen.

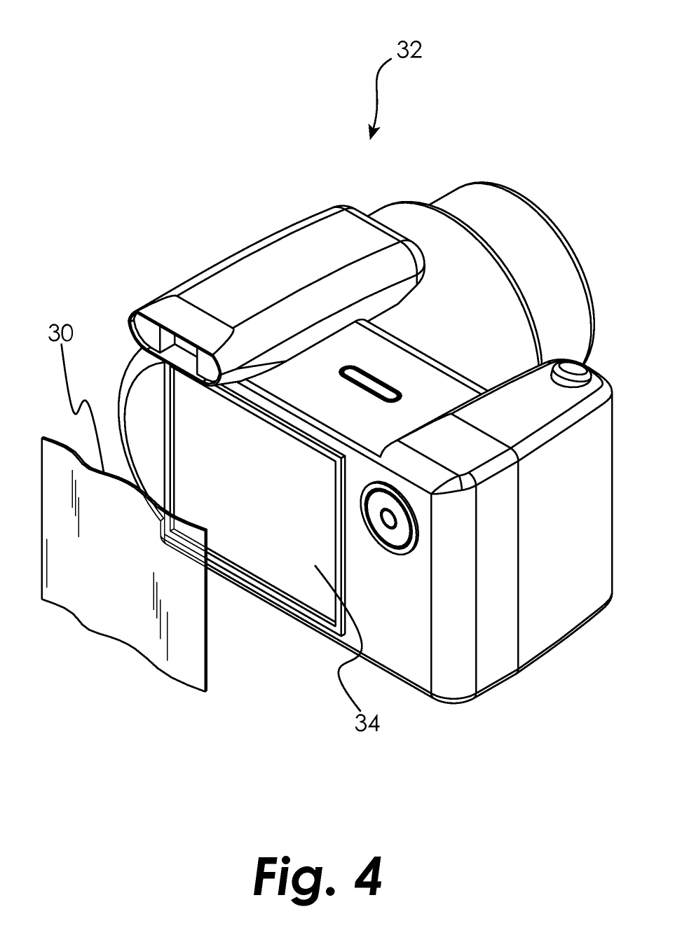

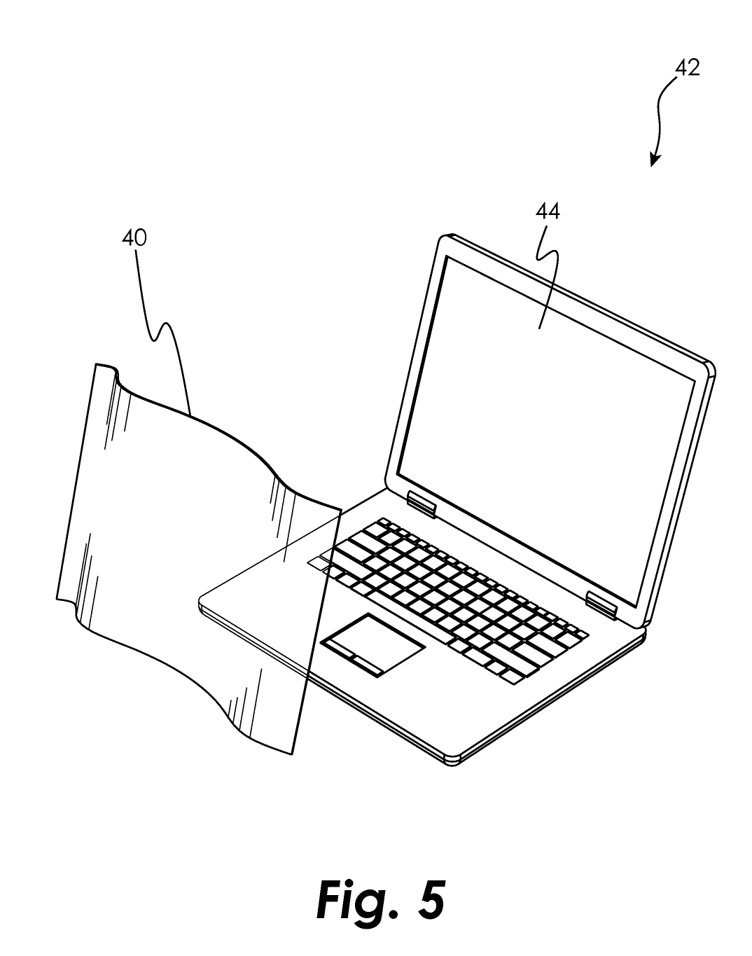

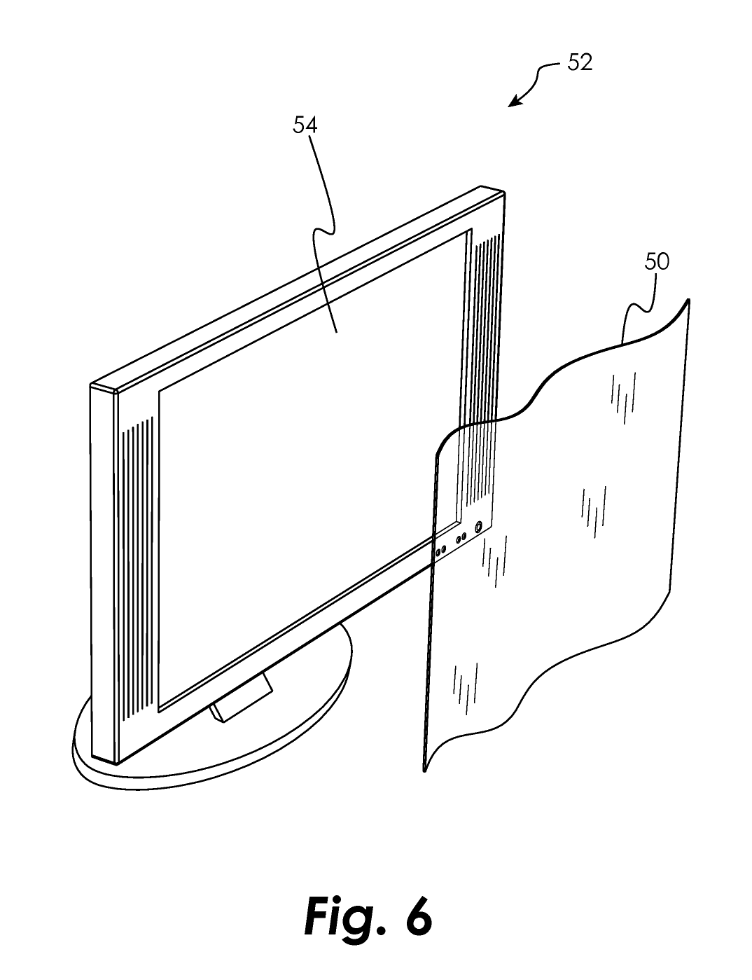

The display screen covers contemplated by the present disclosure may be provided in a variety of sizes and shapes, and configured for use with a variety of display screens, as would occur to one of ordinary skill in the art. FIGS. 2A-6 illustrate a few select non-limiting examples of the various possible sizes, shapes and applications for the display screen covers. As mentioned above, FIGS. 2A-2B illustrate cover 10 configured for application on display screen 16 of computer system 12. As another example, FIG. 3 illustrates a cover 20 configured for use with a cell phone 22 via application on cell phone screen 24. As yet another example, FIG. 4 shows a cover 30 configuration for application on a screen 34 of a camera 32. As a further example, FIG. 5 illustrates a cover 40 configured for use with a laptop 42 via application on the corresponding laptop screen 44. As yet another example, FIG. 6 shows a cover 50 configuration for application on a viewing screen 54 of a television 52.

It should be appreciated that the display screen covers contemplated by the present disclosure may be used with a variety of other display screens as would occur to one of ordinary skill in the art. Additionally, each cover may be used with two or more different display screens, in some embodiments. To that end, the covers may be designed and configured for use with a single display screen, or designed and configured for use with multiple different display screens. Additionally, the display screen covers may be sized to occupy substantially the entire area of a particular display screen, or may be sized to occupy only a portion of the display screen area. It is further contemplated that the display screen covers may be provided in a variety of other appropriate shapes, in addition to the square and rectangular shapes shown in the accompanying figures.

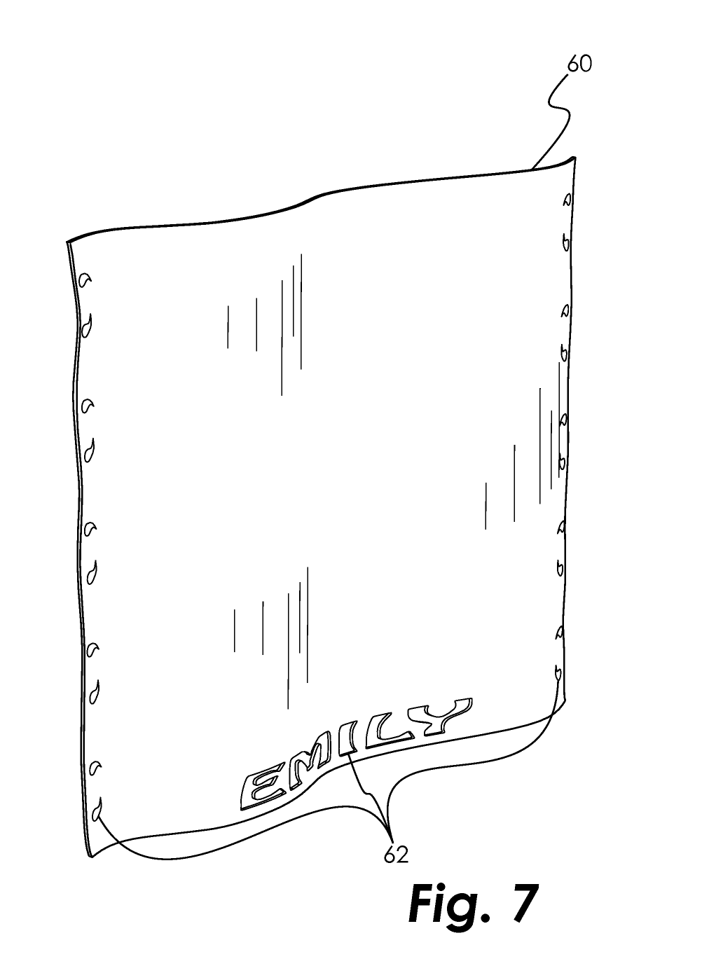

In certain embodiments, the display screen covers contemplated by the present disclosure may optionally include decorative printing or indicia thereon, including a variety of possible designs or stylizations. In certain embodiments, the decorative material may be custom-created based on the user's preferences, including printed messages and/or designs relating to musical groups, television shows, sporting teams, political figures or other items of interest to the user. To provide an example, display screen cover 60 shown in FIG. 7 includes a decorative border 62 including the user's name along the bottom border. The decorative material may optionally be placed at other locations throughout the cover, in addition to or in lieu of a border design.

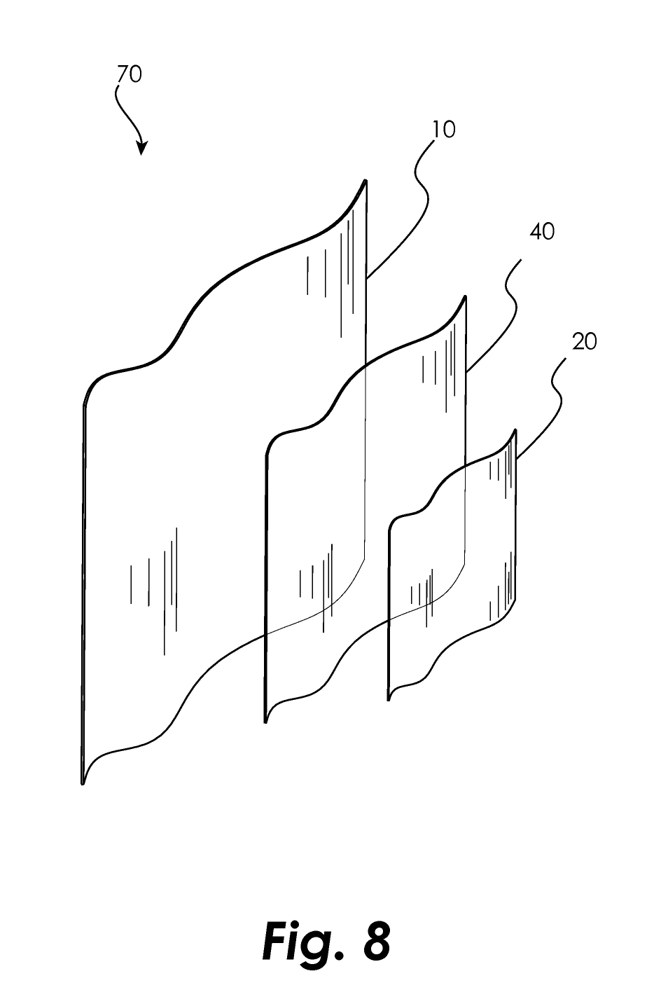

In optional embodiments, two or more display covers may be provided to the user in a set. Example set 70 is illustrated in FIG. 8, including cover 10 configured for use with use computer monitor screen 16 (see FIGS. 2A-2B), cover 20 configured for use with cell phone display screen 24 (see FIG. 3), and cover 40 configured for use with laptop display screen 44 (see FIG. 5). In certain embodiments, the set may include two or more variously-sized display screen covers each having the same personalized refractive power capabilities corresponding to a particular user's refractive error prescription. In this way, the user is provided with multiple display covers of different sizes for use with different-sized display screens. In other embodiments, the set may include multiple display screen covers of the same size and having the same personalized refractive power capabilities, with each cover being individually formed to account for a different viewing distance between the user and the display screen. In such embodiments, the user is provided with multiple covers which may be used with the same display screen to allow for optimized viewing at various distances. In yet other embodiments, the set may include multiple disposable covers having the same personalized refractive power capabilities, so that the display screen covers may be disposed of as desired. Such disposable covers may be particularly useful when at public locations involving display screens accessed by other users. In even other embodiments, the set may include multiple covers having the same relatively large size and having the same personalized refractive power capabilities, which the user can form to desired sizes, such as through trimming or cutting, based on the different-sized display screens accessed by the user. In further embodiments, the set may include multiple display screen covers formed with different magnification levels.

In certain optional embodiments, one or more of the display screen covers may be housed in a carrying case when not in use. As examples, the covers may be rolled up and contained within a cylindrical-shaped case, or may remain flat and contained within a thin polygon-shaped case. Additionally, it should be appreciated that the display screen covers contemplated by the present disclosure may be of a disposable nature or may be reusable. In other optional embodiments, the display screen covers may include properties on at least the screen-facing side of the cover, such as second side 10b of cover 10 (see FIG. 1), which function to protect, clean, preserve and/or enhance the display screen surface. In further optional embodiments, the display screen covers may consist of single covering sheets or multiple pieces of cover material layered together. As one particular example, multiple pieces of cover material may be arranged in various ways to adjust the refractive power capabilities based on different viewing distances between the user and the display screen. In yet other optional embodiments, the display screen covers may include portions having different refractive power capabilities within the same cover. As an example, one half of a single display screen cover may include a first refractive power capability corresponding to a first user's refractive error prescription, while the other half includes a second refractive power capability corresponding to a second user's refractive error prescription. In this way, the display screen cover allows for simultaneous split-screen viewing of a display screen by two different users via the same display screen cover.

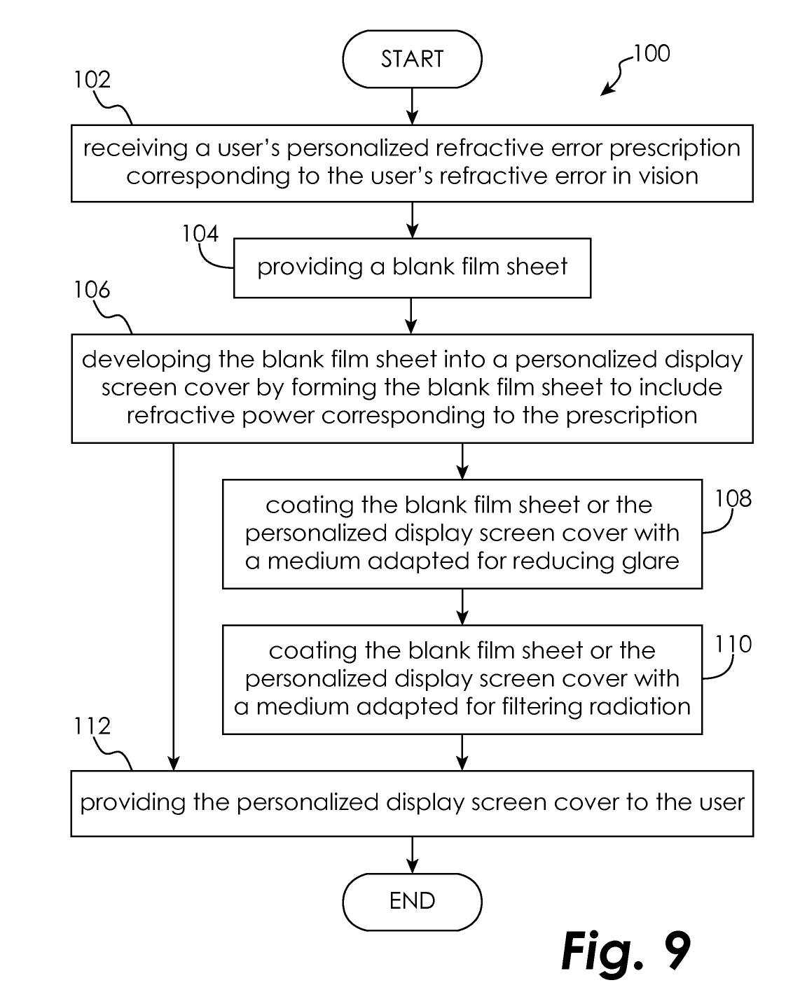

Turning to FIG. 9, there is shown a flow chart representing an example method 100 of forming a personalized display screen cover according to the present disclosure. It should be appreciated that the timing and/or order of the steps in the flow chart can be varied as would occur to one of ordinary skill in the art. The example method 100 begins with receiving a user's personalized refractive error prescription at step 102. The user's prescription corresponds to and is designed to address the user's refractive error in vision. The next step 104 involves providing a blank film sheet from which the personalized display screen cover will be formed. As discussed above, in certain embodiments, the blank film sheet may be composed of a thin and flexible plastic film material. At step 106, the blank film sheet is formed into a personalized display screen cover. The cover is formed to include refractive power capabilities which correspond to the particular user's refractive error prescription.

Two optional steps that may be incorporated into the method are discussed at steps 108 and 110. More specifically, at step 108, the blank film sheet or the display screen cover may be coated with a medium adapted for reducing glare. Additionally, at step 110, the blank film sheet or the display screen cover may be coated with a medium adapted for filtering radiation. Other optional steps and/or features may be incorporated into the method as contemplated by the present disclosure. As an example, another optional step includes averaging a first refractive error prescription for the user's left eye and a second, different refractive error prescription for the user's right eye to obtain an averaged refractive error prescription. In such cases, the forming step 106 includes forming the cover to include refractive power corresponding to the user's averaged refractive error prescription.

At step 112 the personalized display screen cover is provided to the user. The user may apply the cover to a display screen in to a variety of possible manners as discussed above and contemplated by the present disclosure.

While the disclosure has been illustrated and described in detail in the drawings and foregoing description, the same is to be considered as illustrative and not restrictive in character, it being understood that only selected embodiments have been shown and described and that all equivalents, changes, and modifications that come within the spirit of the disclosures as defined herein or by the following claims are desired to be protected.

What is claimed is:

1. A device, comprising a cover configured to releasably adhere to a display screen of an electronic device, the cover being formed with personalized refractive power capabilities corresponding to a user's refractive error prescription to enhance the user's vision of the display screen.

2. The device of claim 1, wherein the cover is configured to releasably adhere to a display screen of an electronic device via static electricity.

3. The device of claim 1, wherein the cover is positionable in a first configuration in which the cover is releasably adhered to a display screen of an electronic device and positionable in a second configuration in which the cover is rolled up when not in use.

4. The device of claim 1, wherein the cover includes a thickness of less than 5 millimeters.

5. The device of claim 1, wherein the cover includes a thickness of less than 1 millimeter.

6. The device of claim 1, wherein the personalized refractive power capabilities include at least one spherical diopeter value and at least one cylindrical diopeter value corresponding to the user's refractive error prescription.

7. The device of claim 1, wherein the cover is composed of a thin and flexible film material.

8. The device of claim 1, wherein the cover is substantially transparent to allow for illumination from the display screen to transmit through the cover.

9. The device of claim 1, wherein the cover is coated with a medium adapted for reducing glare.

10. The device of claim 1, wherein the cover is coated with a medium adapted for filtering radiation.

11. A method, comprising:
receiving a user's personalized refractive error prescription corresponding to the user's refractive error in vision;
providing a blank film sheet;
developing the blank film sheet into a personalized display screen cover, wherein the developing includes forming the blank film sheet to include refractive power corresponding to the prescription; and
providing the personalized display screen cover to the user.

12. The method of claim 11, wherein the personalized display screen cover is configured to releasably adhere to a display screen of an electronic device.

13. The method of claim 11, wherein the receiving includes receiving the user's personalized refractive error prescription for the user's left eye and receiving the user's personalized refractive error prescription for the user's right eye; further comprising averaging the prescriptions for the user's left and right eyes to obtain an averaged refractive error prescription.

14. The method of claim 13, wherein the forming includes forming the blank film sheet to include refractive power corresponding to the averaged refractive error prescription.

15. The method of claim 11, wherein the forming includes forming at least a portion of the blank film sheet into a convex shape to address hyperopia in the user's personalized refractive error prescription.

16. The method of claim 11, wherein the forming includes forming at least a portion of the blank film sheet into a concave shape to address myopia in the user's personalized refractive error prescription.

17. The method of claim 11, wherein the blank film sheet is a thin, flexible film composed of a substantially flat and planar material piece.

18. The method of claim 11, further comprising coating the blank film sheet or the personalized display screen cover with a medium adapted for reducing glare.

19. The method of claim 11, further comprising coating the blank film sheet or the personalized display screen cover with a medium adapted for filtering radiation.

20. The method of claim 11, further comprising providing a set of personalized display screen covers each including refractive power corresponding to the user's prescription, wherein the set includes two or more display screen covers of varying sizes.
